(19) United States
(12) Patent Application Publication
(10) Pub. No.: US 2012/0115699 A1
(43) Pub. Date: May 10, 2012

(54) Machine for Cutting and/or Pre-Creasing a Relatively Rigid Material, Such as For Example Cardboard, A Cutting and/or Pre-Creasing Unit and the Relative Cutting and/or Pre-Creasing Method

(75) Inventor: Giuseppe Capoia, Cimadolmo (IT)

(73) Assignee: PANOTEC SRL, Cimadolmo (IT)

(21) Appl. No.: 13/383,561

(22) PCT Filed: Jul. 13, 2010
(86) PCT No.: PCT/IB2010/001716

§ 371 Date: Jan. 11, 2012

(30) Foreign Application Priority Data
Jul. 13, 2009 (IT) UD2009000132

(51) Int. Cl. B31B 1/20; B31B 1/88; B31B 1/25

(52) U.S. Cl. 493/324; 493/366; 493/361

(57) ABSTRACT

A machine for cutting and/or pre-creasing a sheet of relatively rigid material which includes movement elements to move the sheet in a defined direction of feed, a cutting and/or pre-creasing unit mobile in a direction substantially transverse to the direction of feed of the sheet, to carry out on the sheet at least a cutting and/or pre-creasing operation. The cutting and/or pre-creasing unit includes a plurality of operating heads, each one mobile transversely to the direction of feed of the sheet in an independent and autonomous manner with respect to the other operating heads, and conformed to support, move and command a single relative cutting and/or pre-creasing tool.

### FIELD OF THE INVENTION

The present invention concerns a machine for working relatively rigid material. In particular, the present invention is used for cutting and/or pre-creasing paper, cardboard, plastic material or other, originally in the form of strips or sheets, in order to make containers. Here and in the following description and the claims, by the term sheet we mean, generically, both single pre-cut sheets, and also sheets arriving from rolls or strips. The present invention also concerns a cutting and/or pre-creasing unit, and the method to carry out the cutting and/or pre-creasing of the sheets.

### BACKGROUND OF THE INVENTION

In the packing or packaging sector, plants are known which are used to make containers by means of a plurality of operations on a packaging material, for example a sheet of cardboard.

Known plants generally comprise a plurality of machines operatively disposed in series, and each of which is provided with a support structure substantially transverse to the direction of feed of the sheet.

One type of machine provided in such plants comprises at least a cutting and/or pre-creasing unit having a pair of operating heads, each of which supports, moves and commands both a cutting tool and a pre-creasing tool.

Solutions are known whereby the cutting and/or pre-creasing unit has tools suitable to operate both in a transverse direction to the direction of feed of the sheet, and also in a longitudinal direction to the direction of feed of the sheet.

In some cutting and/or pre-creasing conditions one and/or the other tool of each operating head can remain unused, limiting the potential productivity of the machine.

Such known plants are little suited for production in small series, and need long fitting out times to change to producing series which are different from each other.

Moreover, since in the known machines the tools are provided in pairs for each operating head, possible parallel operations distanced only a few millimeters from each other are difficult to carry out, possibly causing operational inaccuracies.

Purpose of the present invention is to achieve a machine and a unit, and to perfect a method, for cutting and/or pre-creasing, which are suitable for small productions, which allow to exploit to the maximum the potential productivity of the machine and which are less bulky, more accurate and cost less.

The Applicant has devised, tested and embodied the present invention to overcome the shortcomings of the state of the art and to obtain these and other purposes and advantages.

### SUMMARY OF THE INVENTION

The present invention is set forth and characterized in the independent claims, while the dependent claims describe other characteristics of the invention or variants to the main inventive idea.

In accordance with the above purpose, a machine for cutting and/or pre-creasing a sheet of relatively rigid material comprises at least movement means able to feed the sheet at least in a defined direction of feed.

The machine according to the present invention also comprises cutting and/or pre-creasing means provided with at least a cutting and/or pre-creasing unit movable in a direction substantially transverse to the direction of feed of the sheet, and able to carry out at least a cutting and/or pre-creasing operation on the sheet.

The cutting and/or pre-creasing means are disposed below a hypothetical feed plane of the sheet.

According to a variant, the machine according to the present invention can also have a printing unit.

According to a characteristic feature of the present invention, the cutting and/or pre-creasing unit comprises a plurality of operating heads, each one mobile in a direction transverse to the direction of feed of the sheet in an independent and autonomous manner with respect to the other operating heads.

Moreover, each operating head is conformed to support, move and command a single relative cutting and/or pre-creasing tool.

The present invention thus allows to dispose in an independent and autonomous manner each single tool provided, according to the operating needs of cutting and/or pre-creasing.

In this way, each cutting and/or pre-creasing operation on the sheet is managed independently from the others, increasing the possibilities of working and adjusting the position of the individual tools.

Therefore it is also possible to carry out parallel and close cutting and/or pre-creasing operations, precisely and without causing long and onerous fitting out times.

Moreover, since the individual cutting and/or pre-creasing tools are assembled on specific operation heads which are independent with respect to each other, on the same machine, different disposition patterns for the tools can be provided, so that different operations on different sheets can be carried out at the same time. In other words, with the present invention, operations that are quite different from each other can be carried out in tandem.

This possibility is particularly advantageous for small productions for which the fitting out between different series, or the acquisition of two machines, would be too heavy an investment.

According to a variant, each operating head comprises a relative movement member on board, such as an electric motor.

According to another variant, on the same machine two cutting and/or pre-creasing units according to the present invention are provided, in particular a first able to carry out cutting and/or pre-creasing operations in a direction substantially longitudinal to the direction of feed of the sheet, and a second able to carry out the cutting and/or pre-creasing operations in a direction substantially transverse to the direction of feed of the sheet.

In this way it is possible to use a single machine to carry out subsequent operations in different directions, for example in directions substantially perpendicular with respect to each other, in a completely automated manner.

According to another variant, the sheet to be cut and pre-creased is placed with the enhanced surface turned upward and the cutting and/or pre-creasing units are located below the feed plane of the sheet.

This operating condition allows to improve the operating conditions of a possible printing head, in which the possibility of impurities and residue powder being deposited is reduced to a minimum, if not substantially eliminated.

### BRIEF DESCRIPTION OF THE DRAWINGS

These and other characteristics of the present invention will become apparent from the following description of a preferential form of embodiment, given as a non-restrictive example with reference to the attached drawings wherein:

FIG. 1 is a three-dimensional view of a cutting and/or pre-creasing machine according to the present invention;

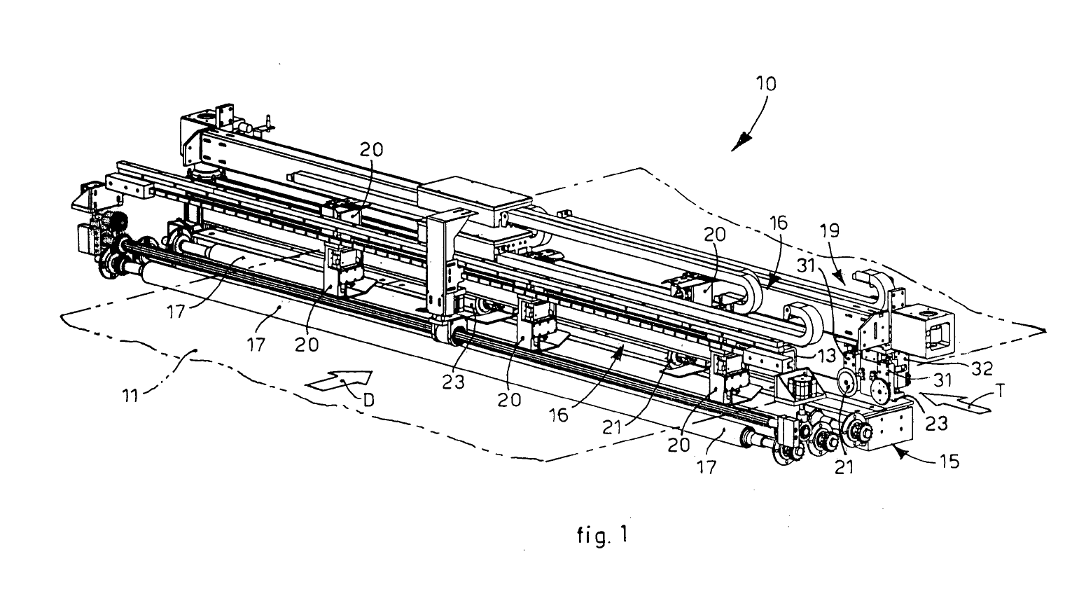

FIG. 2 shows a plane view of the machine in FIG. 1 in a possible operating step;

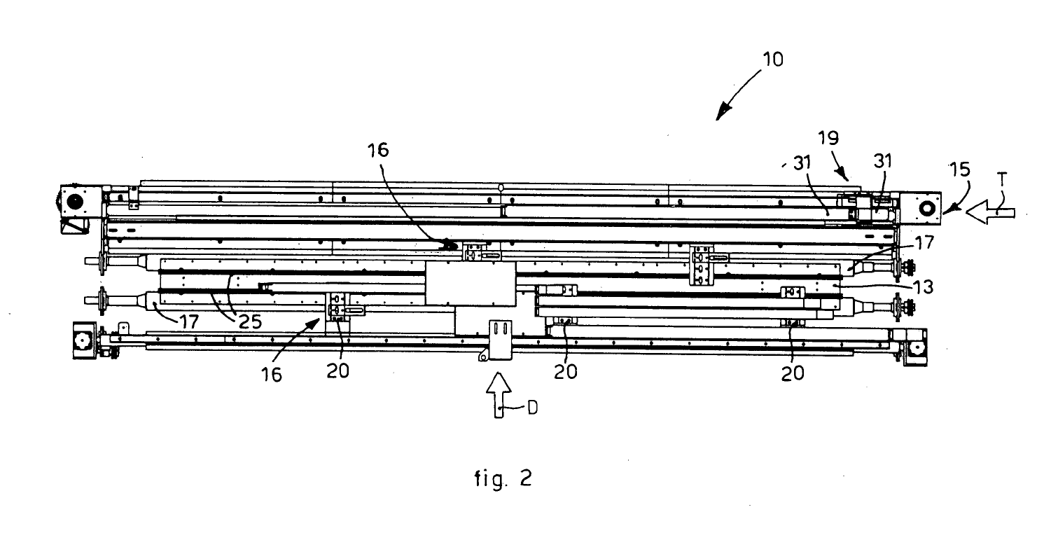

FIG. 3 shows a lateral view of an enlarged detail of the machine in FIG. 1;

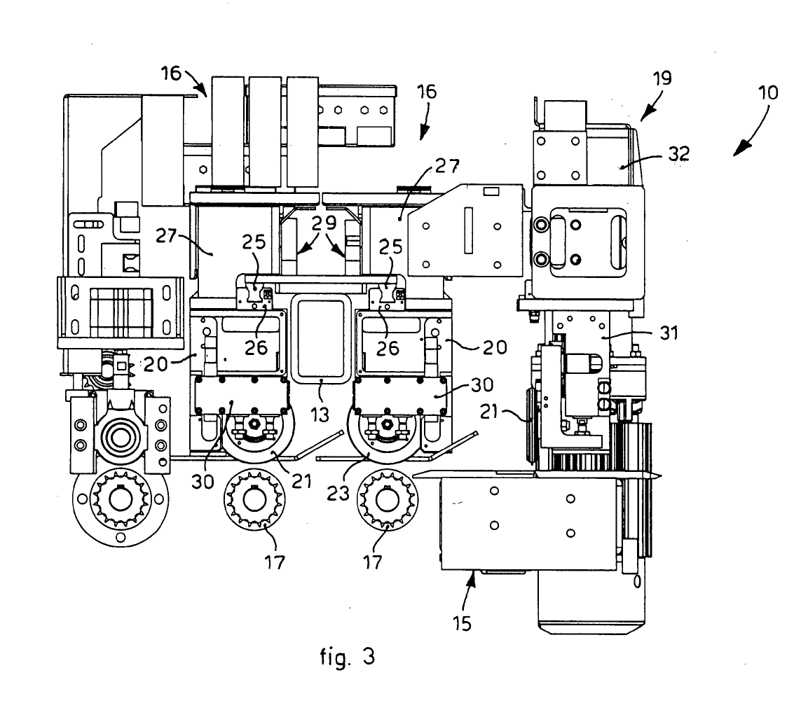

FIG. 4 shows a front view of the machine in FIG. 1;

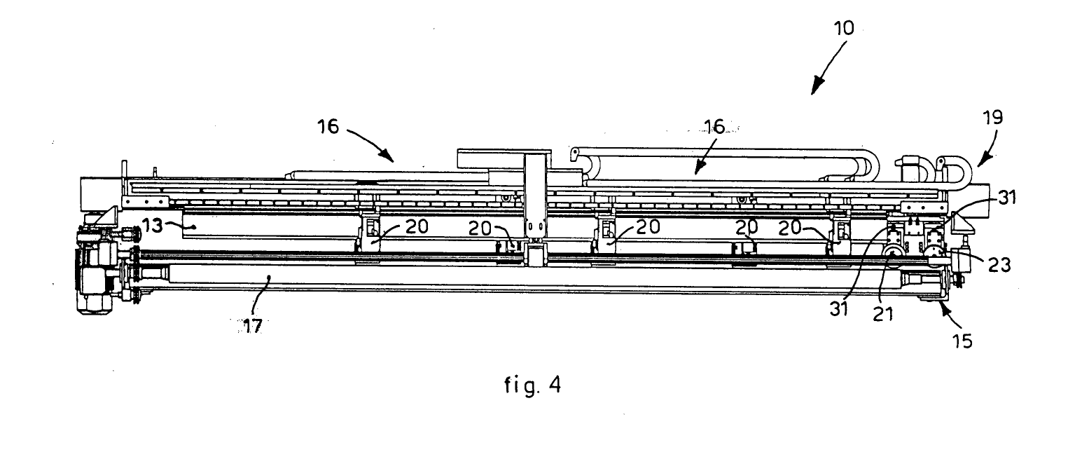

FIG. 5 shows, with a front view, an enlarged detail of FIG. 3.

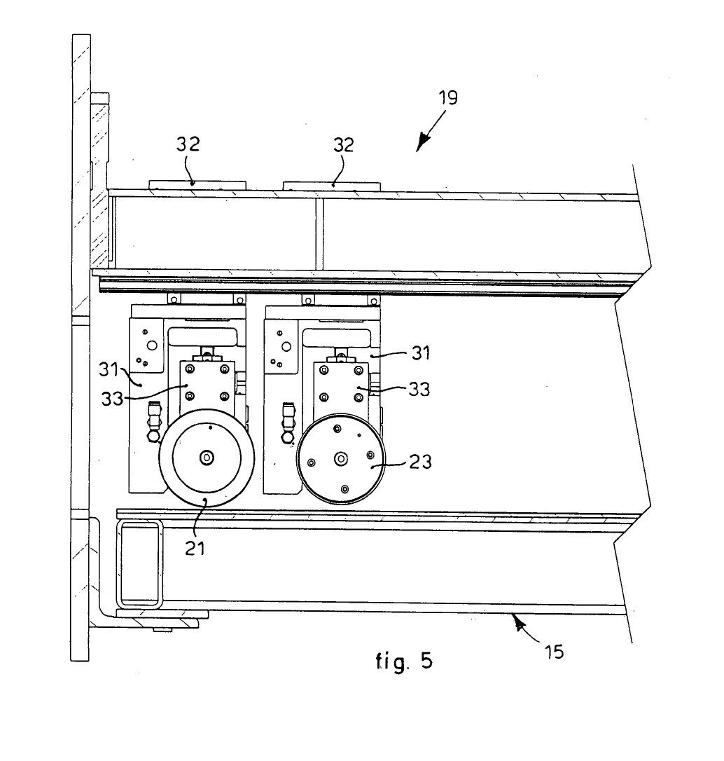

### DETAILED DESCRIPTION OF A PREFERENTIAL FORM OF EMBODIMENT

With reference to the attached drawings, a machine 10 according to the present invention is used to carry out cutting and/or pre-creasing operations on a relatively rigid material, in this case a sheet 11 of cardboard, which for example can be a single sheet, a sheet of a continuous module but even a portion of a strip, a sheet coming from a pile, or two or more sheets arriving from two or more piles and fed in parallel to the machine 10.

Simply to give an example, the pre-creasing or cutting carried out on the sheet 11 of cardboard by the machine 10 is intended to promote the precise and linear folding of the cardboard, for example in the automated production steps of a packing box.

The machine 10 according to the present invention comprises a support structure 15, disposed transversely with respect to a direction of feed D of the sheets 11.

Two longitudinal cutting and/or pre-creasing units 16 are assembled on the support structure 15, disposed in sequence to each other, and a transverse cutting and/or pre-creasing unit 19 positioned downstream of the two longitudinal units 16.

To give a non-restrictive example, the machine 10 according to the present invention also comprises a feeding/introduction unit for the sheets 11 and an extraction unit with motorized roller/rollers. The latter units are of a substantially known type and are not shown in the attached drawings.

The longitudinal units 16 and the transverse unit 19 are inverted with respect to the feed plane of the sheet 11, so as to define a cutting and/or pre-creasing operation from the bottom to the top.

Each longitudinal unit 16 comprises a plurality of operating heads 20 independent from each other and mobile in a transverse direction T to the direction of feed D of the sheet 11, along relative support beams 13 of the support structure.

In particular each operating head 20 is assembled sliding on the relative support beam 13 by means of relative linear guides 25 and sliding blocks 26.

The independent movement of each operating head 20 with respect to the relative support beam 13 is achieved by means of an electric motor 27 assembled on board the operating head 20 and kinematically connected to the support beam 13 by means of a relative pinion gear and rack 29.

Each operating head 20 is suitable to support, move and command a relative cutting tool 21, or alternatively, a relative pre-creasing tool 23.

In particular, in the longitudinal unit 16, the operating heads 20 are conformed to maintain the relative cutting tool 21 or pre-creasing tool 23 in such a way that one or other of the latter operate in a direction substantially longitudinal to the direction of feed D of the sheet 11.

Each operating head 20 also comprises a pressure member 30, kinematically connected to the cutting tool 21 or the pre-creasing tool 23, so as to determine the operating pressure of the relative tool 21 or 23, on the sheet 11, and also a condition wherein the cutting and/or pre-creasing tool 21, 23 is raised from the sheet 11.

In this way, for each cutting and/or pre-creasing operation to be carried out on the sheet 11, each individual operating head 20 is moved individually and independently of the others, in order to position the relative cutting tool 21 and/or pre-creasing tool 23 in a determinate predefined work position.

In a possible operating configuration, each longitudinal group 16 has relative operating heads 20 having, respectively, cutting tools 21 for the first longitudinal unit 16 and pre-creasing tools 23 for the second unit.

In this possible configuration of the present invention the operating heads 20 of each longitudinal unit 16 are disposed aligned with each other with respect to the direction of feed of the sheet 11, so as to be able to perform in sequence, and in an aligned manner, the necessary cutting and/or pre-creasing operations.

The transverse unit 19 comprises one or more operating heads 31, in this case too, mobile in an independent manner with respect to each other and suitable to support, move and command a relative cutting tool 21, or alternatively, a relative pre-creasing tool 23.

In particular the operating heads 31 are conformed to maintain the relative cutting tool 21 or pre-creasing tool 23 in such a way that one or the other of the latter operate in a substantially transverse direction T to the direction of feed D of the sheet 11.

As for the operating heads 20 of the longitudinal unit 16, the movement in the transverse direction T of the operating heads 31 is achieved by means of relative electric motors 32 assembled on board the operating heads.

Moreover, each operating head 31 comprises a pressure member 33, which is kinematically connected to the cutting tool 21 or the pre-creasing tool 23, in order to determine the operating pressure of the relative tool 21 or 23, on the sheet 11, and also a condition wherein the cutting and/or pre-creasing tool 21, 23 is raised from the sheet 11.

In the same way as the operating heads 20, each individual operating head 31 is moved individually and independently from the others, in order to position the relative cutting tool 21 and/or the pre-creasing tool 23, in a determinate predefined work position.

The machine 10 also comprises a plurality of movement rollers 17 disposed on the opposite side to the longitudinal units 16 and the transverse unit 19 with respect to a hypothetical horizontal feed plane of the sheet. The movement rollers 17 determine the feed of the sheet 11 in a determinate direction of feed D in cooperation with the longitudinal units 16 and the transverse unit 19.

The movement rollers 17 also have the function of contrasting the cutting and/or pre-creasing action carried out by the tools 21 and 23.

According to a variant, the movement rollers 17 can be made both of rubber and iron, for example to carry out cutting operations on iron.

The machine 10 also comprises a control and command unit, not shown, which is electronically connected to the movement members of each operating head 20 and 31, to coordinate according to a desired operating program the positioning and drive of each single cutting tool 21 and/or pre-creasing tool 23.

It is clear, however, that modifications and/or additions of parts may be made to the machine 10, to the units 16 and 19 and to the cutting and/or pre-creasing method as described heretofore, without departing from the field and scope of the present invention.

For example, it comes within the scope of the present invention to provide that the machine 10 also comprises a printing device, not shown, disposed on the opposite side of the longitudinal units 16 and the transverse unit 19, with respect to the feed plane of the sheet 11.

According to another variant, the transverse unit 19 is not provided and downstream of the longitudinal units 16 a rotation device is provided, for example a rotating plate, able to rotate the sheet 11 by 90° and feed it in the opposite direction toward the longitudinal units 16.

According to a further variant, the machine comprises means to detect the position of the sheet 11, for example of the optical type or other, connected to the control and command unit, for example to produce an error signal.

It also comes within the scope of the present invention to provide that instead of the cutting tools 21 and/or pre-creasing tools 23, each operating head 20, 31 carries a single punching tool, such as a punch with an abutment plane/counter-mold. In this way, with the various operating heads 20, 31 individually equipped, also static operations can be carried out in order to make various drawings on the sheets 11.

It is also clear that, although the present invention has been described with reference to specific examples, a person of skill in the art shall certainly be able to achieve many other equivalent forms of machine for cutting and/or pre-creasing a relatively rigid material such as cardboard, a cutting and/or pre-creasing unit and a relative cutting and/or pre-creasing method, having the characteristics as set forth in the claims and hence all coming within the field of protection defined thereby.

1. Machine for cutting and/or pre-creasing a sheet of relatively rigid material comprising
movement means able to move said sheet at least in a defined direction of feed (D),
cutting and/or pre-creasing means provided with at least a cutting and/or pre-creasing unit mobile in a direction substantially transverse to the direction of feed of said sheet, and for carrying out on said sheet at least a cutting and/or pre-creasing operation,
wherein the cutting and/or pre-creasing unit comprises a plurality of operating heads, each one mobile in said transverse direction (T) to the direction of feed (D) of the sheet in an independent and autonomous manner with respect to the other operating heads, and conformed to support, move and command a single relative cutting and/or pre-creasing tool, and wherein the cutting and/or pre-creasing means are disposed below a hypothetical feed plane of the sheet.

2. The machine as in claim 1, wherein each operating head comprises a relative movement member on board, for defining the movement thereof in said transverse direction (T) to the direction of feed (D) of the sheet.

3. The machine as in claim 2, wherein said movement member is an electric motor kinematically connected to a fixed support structure by a relative pinion gear and rack.

4. The machine as in claim 1, wherein each operating head comprises a pressure member kinematically connected to the relative cutting and/or pre-creasing tool, to determine a determinate operating pressure of said cutting and/or pre-creasing tool on the sheet, and also a condition wherein said cutting and/or pre-creasing tool is raised from the sheet.

5. The machine as in claim 1, wherein the cutting and/or pre-creasing means comprise two cutting and/or pre-creasing units, wherein a first said unit is for carrying out cutting and/or pre-creasing operations in a direction substantially longitudinal to the direction of feed (D) of the sheet, and a second unit is for carrying out cutting and/or pre-creasing operations in a direction substantially transverse (T) to the direction of feed (D) of the sheet.

6. The machine as in claim 5, comprising in sequence two said first units and a said second unit.

7. The machine as in claim 1, comprising a printing unit disposed on the opposite side to the at least one cutting and/or pre-creasing unit, to print at least one surface of the sheet opposite to that on which the cutting and/or pre-creasing operations are carried out.

8. A cutting and/or pre-creasing unit for cutting and/or pre-creasing a sheet of relatively rigid material,
said cutting and/or pre-creasing unit being mobile in a direction substantially transverse (T) to the direction of feed (D) of said sheet, and for carrying out on the sheet at least a cutting and/or pre-creasing operation, comprising a plurality of operating heads, each operating head mobile in said transverse direction (T) to the direction of feed (D) of the sheet in an independent and autonomous manner with respect to the other operating heads, and conformed to support, move and command a single relative cutting and/or pre-creasing tool, and wherein said cutting and/or pre-creasing unit is disposed below a hypothetical feed plane of the sheet.

9. A method for cutting and/or pre-creasing a sheet of relatively rigid material comprising
using a cutting and/or pre-creasing means provided with at least a cutting and/or pre-creasing unit mobile in a direction substantially transverse (T) to the direction of feed of said sheet to carry out at least a cutting and/or pre-creasing operation on the sheet,
the cutting and/or pre-creasing unit provides at least a movement step in which a plurality of operating heads of the cutting and/or pre-creasing unit are moved in said transverse direction (T) to the direction of feed (D) of the sheet in an independent and autonomous manner with respect to each other,
each operating head being conformed to support, move and command a single relative cutting and/or pre-creasing tool, and
the cutting and/or pre-creasing means being disposed below a hypothetical feed plane of the sheet.

10. The method of claim 9, wherein each operating head comprises a relative movement member on board, defining the movement thereof in said transverse direction (T) to the direction of feed (D) of the sheet.

11. The method of claim 9, wherein said movement member is an electric motor kinematically connected to a fixed support structure by a relative pinion gear and rack.

12. The method of claim 9, wherein each operating head comprises a pressure member kinematically connected to the relative cutting and/or pre-creasing tool, which determines a determinate operating pressure of said cutting and/or pre-creasing tool on the sheet, and also a condition wherein said cutting and/or pre-creasing tool is raised from the sheet.

13. The method of claim 9, wherein the cutting and/or pre-creasing means comprise two cutting and/or pre-creasing units, wherein a first said unit carries out cutting and/or pre-creasing operations in a direction substantially longitudinal to the direction of feed (D) of the sheet, and a second unit carries out cutting and/or pre-creasing operations in a direction substantially transverse (T) to the direction of feed (D) of the sheet.

14. The method of claim 13, comprising in sequence two said first units and a said second unit.

15. The method of claim 9, comprising a printing unit disposed on the opposite side to the at least one cutting and/or pre-creasing unit, which prints at least one surface of the sheet opposite to that on which the cutting and/or pre-creasing operations are carried out.
